(19) United States
(12) Patent Application Publication
(10) Pub. No.: US 2008/0037724 A1
(43) Pub. Date: Feb. 14, 2008

(54) Natural language load alerts

(76) Inventors: Michelle Hernandez, St. Augustine, FL (US); Peter Wojnar, Jacksonville, FL (US); Wayne Sepega, Jacksonville, FL (US); Andy Wilbourn, Orange Park, FL (US); Eduardo Marquez, St. Augustine, FL (US); Angie Abbott, Ponte Vedra Beach, FL (US); Marshall Harrison, Jacksonville, FL (US); Michael Waldrop, Jacksonville, FL (US); Thom Pantazi, Jacksonville, FL (US); Patrick Wise, Ponte Vedra Beach, FL (US)

Correspondence Address: HOLLAND & KNIGHT LLP, 10 ST. JAMES AVENUE, 11th Floor, BOSTON, MA, 02116-3889, US

(21) Appl. No.: 11/483,805

(22) Filed: Jul. 10, 2006

(51) Int. Cl. H04M 1/64

(52) U.S. Cl. 379/88.12

(57) ABSTRACT

Methods and apparatus, including computer program products, for natural language load alerts. A method includes, in a server residing in a network of interconnected computers, maintaining a database of users and related load preferences, maintaining a database of available loads and related load information, and generating a natural language load alert message when an available load matches load preferences of a user. The method can include sending the natural language load alert message as a voice message to the user using telephony services and receiving a voice instruction from the user in response to the natural language load alert message as a voice message.

### BACKGROUND

The present invention relates to data processing by digital computer, and more particularly to natural language load alerts.

Independent truck owners are generally referred to as independent capacity providers or business capacity owners (BCOs). Each BCO can be considered to be a chief executive officer (CEO) of his or her own company and, as such, in charge of making all the decisions regarding their business. These business decisions affect annual income, work schedules, business strategies, what freight to haul, where to travel, the type of equipment they operate, when to go home, and so forth.

BCOs make money hauling loads from destination to destination. No money is made hauling an empty trailer from destination to destination. Optimally, a BCO would like to haul a load from a first geographic location to a second geographic location, be notified of available loads at the second geographical location (generally referred to as “load alerts”), and haul an available load from the second geographic location to a third geographic location. In effect, this maximizes utilization and income for the BCO.

Current load alert systems require a BCO to access a computer server using a wired or wireless network and check whether available loads have been posted on the server using a database search. When a load is available, these systems often require the BCO to drill down the details of any particular posted load to determine if the posted load requirements can be fulfilled, or are desired, by the BCO.

### SUMMARY

The present invention provides methods and apparatus, including computer program products, for natural language load alerts.

In one aspect, the invention features a computer-implemented method including, in a server residing in a network of interconnected computers, maintaining a database of users and related load preferences, maintaining a database of available loads and related load information, and generating a natural language load alert message when an available load matches load preferences of a user.

In embodiments, the method can include sending the natural language load alert message as a voice message to the user using telephony services. The method can include receiving a voice instruction from the user in response to the natural language load alert message as a voice message.

The users can be independent capacity providers and/or business capacity owners (BCOs). Independent capacity providers can include employees of a company, including those who work away from the office.

The load preferences can be selected from the group including type, expiration date, origin city, origin state, origin radius, pickup date, destination city, destination state, destination radius, preloaded, trailer group, trailer type, rate per mile, minimum revenue, team load, subscription name, status, and contact telephone number.

The load information can be selected from the group including type, origin city/state, destination city/state, schedule information, and financial information.

Generating a natural language load alert message can include building a load alert text message from the match, and converting the load alert text message to a natural language load alert voice message.

The database of available loads can include freight.

The voice instruction can include an instruction to suspend sending a subsequent natural language load alert message.

The method can include generating a natural language load alert message when information pertaining to the available load changes.

The method can include generating a natural language load alert message when information pertaining to the available load matches a predicted location of the user.

In another aspect, the invention features a system including a subscription management module enabling a first type of user to manage information pertaining to load preferences and a second type of user to manage information pertaining to available loads, a notification services module enabling a generation of a load alert text message when an available load matches load preferences of a user, and a delivery services module enabling conversion of the load alert text message to a natural language load alert voice message and sending of the natural language alert voice message to the user over telephony services.

In embodiments, the delivery services module can include a speech server. The speech server can include speech engine services (SES), and telephone application services (TAS). SES can enable scalable and fault-tolerant access to speech recognition and text-to-speech (TTS) resources for telephony and multimodal applications.

Information pertaining to load preferences can be selected from the group including type, expiration date, origin city, origin state, origin radius, pickup date, destination city, destination state, destination radius, preloaded, trailer group, trailer type, rate per mile, minimum revenue, team load, subscription name, status, and contact telephone number.

Information pertaining to available loads can be selected from the group including type, origin city/state, destination city/state, schedule information, and financial information.

The delivery services module can enable receipt of a voice instruction from the user.

Available loads can represent freight.

The first type of user can be an independent capacity provider. The second type of user can be an agent.

The invention can be implemented to realize one or more of the following advantages.

An independent capacity provider or business capacity owner (BCO) is not required to have computer network access to be alerted of available loads.

An independent capacity provider receives load alerts using standard land line telephones or mobile wireless devices, such as, for example, cellular phones, personal data assistants (PDAs) with integrated cellular phones, and so forth.

A text load alert, meeting independent capacity provider preferences, is delivered to a speech server where it is converted to a natural language load alert message and pushed out over a telephone network to a telephone device of an independent capacity provider. The independent capacity provider can interact with the received natural language load alert message.

Natural language load alerts make alerts available to existing telecommunication systems without the need for computer network solicitation and interaction.

Natural language load alerts increase revenues per independent capacity provider vehicle by increasing the number of loads matched to independent capacity provider preferences.

Natural language load alerts improve productivity by eliminating effort for independent capacity providers.

Natural language load alerts improve independent capacity provider and agent retention by offering a frequently requested service that helps them move their loads and make more money while decreasing their load matching effort.

Natural language load alerts increase the number of available independent capacity providers resulting in greater automation of independent capacity provider and agent interaction.

A system enables an independent capacity provider to create and manage load preferences including type of load, type of equipment, load amount, rate per mile, and so forth, so that natural language load alerts are only received if an available load matches the independent capacity provider preferences.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary natural language load alert system.

FIG. 2 is a block diagram of an architecture of the application services of the natural language load alert system.

FIG. 3 is a flow diagram of a natural language load alert process.

Like reference numbers and designations in the various drawings indicate like elements.

### DETAILED DESCRIPTION

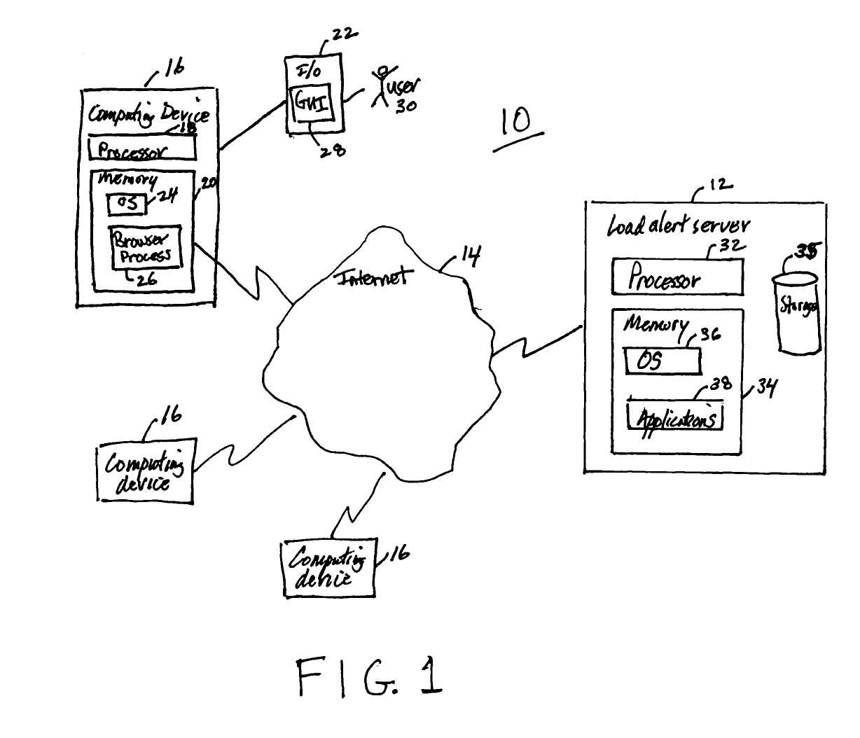

As shown in FIG. 1, an exemplary natural language load alert system 10 includes a load alert server 12 linked to a network 14 of interconnected computers, such as the Internet, and one or more remote computing devices 16. Each of the remote computing devices 16 includes a processor 18, a memory 20 and an input/output device 22. Memory 20 includes an operating system 24, such as Linux or Windows®, and a browser process 26, such as Firefox™, Opera™, Flock™ or Internet Explorer™. Browser process 26 displays a graphical user interface (GUI) 28 on the input/output device 22 for a user 30.

The load alert server 12 includes a processor 32, memory 34 and a storage device 35. Memory 34 includes an operating system 36 and applications 38 integrated with natural language alert notification services that send natural language alert notifications to users. The users are generally referred to as independent capacity providers or business capacity owners (BCOs), such as long haul tractor truck drivers. Natural language alert notifications represent available loads posted by agents to the load alert server 12 meeting user preferences/requirements pertaining to desired loads. More particularly, the applications 38 enable users to be notified about available loads of interest as they are posted to the load alert server 12 by telephone, without a need for online access to the load alert server 12 or electronic mail (email) access.

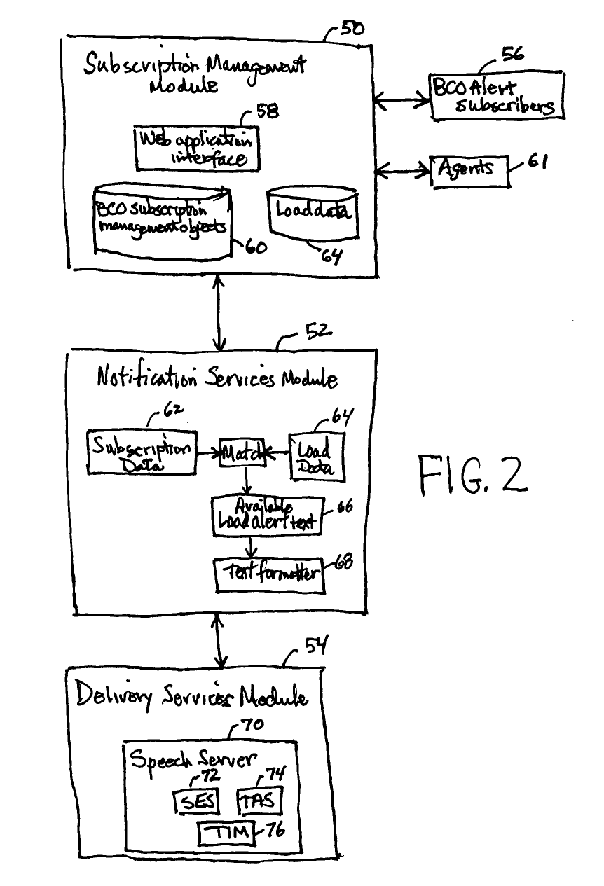

As shown in FIG. 2, an architecture 48 of the applications 38 includes a subscription management module 50, a notification services module 52 and a delivery services 54 module. Subscription management module 50 enables users, e.g., alert subscribers 56, using a web application interface 58, to add/edit/delete/modify subscription management objects 60. Subscription management module 50 enables users, e.g., agents 61, using the web application interface 58, to add/edit/delete/modify information about available loads, i.e., load data 64.

The subscription management module 50 provides a repository of users generally referred to as subscribers, each subscriber having unique needs and capabilities with respect to the hauling of loads. These needs can include, for example, type of load desired, geographical locations of pickup and delivery of loads, cost per mile desired, and so forth. Each subscriber is an independent capacity owner that transports loads from destination to destination and can maximize their revenues when a load is carried from destination to destination.

In a preferred example, the subscription management module 50 is implemented using SQL Server from Microsoft Corporation of Redmond, Wash.

Subscription management objects 60 can include any one or more of a number of data elements/attributes for each subscription. For example, “type” designates the type of subscription. One type is referred to as “follow me.” A subscriber will have his/her follow me subscription automatically reactivated when a new location for his/her availability is known. More specifically, suspension of follow me alerts is released when the available load location is updated, such as when the subscriber gets booked on a new load and has a new destination city.

“Expiration date” contains the date the subscription will change a status from active to inactive.

“Origin city” contains the city from which the user wants a load search to be initiated.

“Origin state” contains the state from which the user wants a load search to be initiated.

“Origin radius” contains the mileage from the origin state that the user wants the search to be expanded to.

“Pickup date” contains the date the truck is available to pick up another load.

“Destination city” contains the name of the city the user wants to drop off a load.

“Destination state” contains the name of the state the user wants to drop off a load.

“Destination radius” contains the distance from the destination city that the user is willing to go to drop off a load.

“Preloaded” is used to convey whether the user desires a trailer that is already preloaded.

“Trailer group” contains the group of trailer the user wants to pull the load.

“Trailer type” contains the type of trailer the user wants to pull for the load.

“Rate per mile” contains the minimum rate per mile that a user wants for the load.

“Minimum revenue” contains the minimum revenue that the user wants for the load.

“Team load” is used to convey whether the user wants a team load or not.

“Subscription name” contains the name of the subscription.

“Status” contains the current status of the subscription, i.e., active or inactive.

“Contact #” contains the phone number used to connect to the capacity provider.

The subscription management module 50 also provides a repository of available loads added by agents, each available load having specific characteristics, such as, for example, load location, type, ultimate destination, desired delivery date, and so forth.

The notification services module 52 enables matching of subscription data 62 and available load data 64 to generate available load alerts data 66 as text data, which is formatted 68 and sent to the delivery services module 54. Subscription data 62 is populated with subscription management objects generated in response to inputs from alerts subscribers 56. Available load data 64 is populated in response to inputs from agents with available loads. In a preferred example, the notification services module 52 is implemented using SQL Server from Microsoft Corporation of Redmond, Wash.

The delivery services module 54 includes a speech server 70. The speech server 70 can include speech engine services (SES) 72 and telephone application services (TAS) 74. The speech server 70 converts load alert text data to a natural language load alert and sends the natural language load alert as a voice message to the appropriate subscriber or subscribers using telephone technology implemented in a telephony interface manager (TIM) 76. Telephone technology includes traditional land line telephone systems, wireless (i.e., cellular) systems, and so forth. In a preferred example, the delivery services module 54 is implemented using Speech Server™ from Microsoft Corporation of Redmond, Wash. p SES 72 provides scalable and fault-tolerant access to speech recognition and text-to-speech (TTS) resources for telephony and multimodal applications. SES 72 enables scale-out and multiple-node redundancy using standard IP load balancing, supports dynamic grammar loading and caching, and compiled grammars, allows mixed-initiative applications, and provides robust data logging for application dialog and speech recognition engine tuning. SES 72 includes automatic speech recognition (ASR) engines supporting, for example, English, Spanish and French languages.

SES 72 includes a Text-to-Speech engine, such as ScanSoft® Speechify text-to-speech (TTS) engines, supporting, for example, English, Spanish, and French languages. SES 72 can include a prompt engine for playing pre-recorded WAV file format audio prompts and receive audio inputs from subscribers telephoned with a voice message regarding one or more available loads.

TAS 74 provides a scalable and fault-tolerant application runtime environment for speech and touchtone telephony applications. TAS 74 supports multiple concurrent telephony applications running on a single TAS node, processes application dialogues, call control, speech requests, and call logging, interprets Speech Application Language Tags (SALT)-enabled HTML via a SALT interpreter, handles DTMF (touchtone) and speech applications, coordinates all media processing and speech recognition requests, and so forth. TAS 74 supports a wide range of call control features, such as call answer, call placement, and call transfer.

In operation, a subscriber inputs subscription data 62, including preferences, through the subscription management module 50. Agents input available load data 64 to the subscription management module 50. The notification services module 52 periodically or continuously compares subscription data 62 and available load data 64. When a match is found between, for example, particular subscription data 62 and available load data 64, the available load 64 is stored as available load alert data 66 for the particular subscriber. The available load alert data 66 is text that is formatted by the content formatter 68 and sent to the delivery services module 54. The speech server 70 in the delivery services module 54 converts the received formatted load alert text data to a natural language load alert and sends it as a natural language load alert voice message to the appropriate subscribers using TIM 76.

In one particular example, a subscriber receiving the natural language load alert voice message can suspend the alert using a voice command. In another particular example, a subscriber can have a “follow me” subscription. A subscriber will have his/her follow me subscription automatically reactivated when a new location for his/her availability is known. More specifically, suspension of follow me alerts is released when the available load location is updated, such as when the subscriber is booked on a new load and has a new destination city.

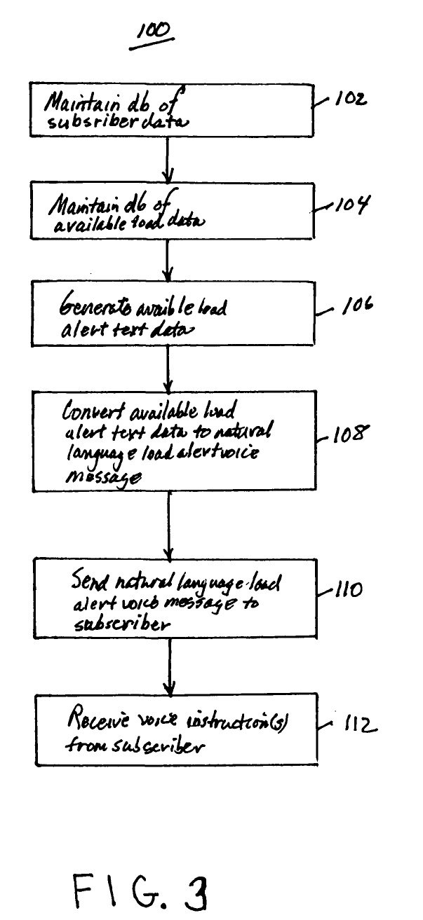

As shown in FIG. 3, a natural language alert process 100 includes maintaining (102) a database of subscriber data. The subscriber data includes contact information and subscriber preferences with respect to desired shipping loads. Process 100 maintains (104) a database of available load data. The available load data includes type, location, destination, costs, and so forth.

Process 100 generates (106) available load alert text data for a subscriber when subscriber preferences in the subscriber database match available load data in the available load database.

Process 100 converts (108) the generated available load alert text data to a natural language load alert voice message and sends (110) the natural language load alert voice message to the subscriber using telephony services.

Process 100 can receive (110) voice instructions from the subscriber in response to the sending. Voice instructions can include suspending the particular load alert notification.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising,
in a server residing in a network of interconnected computers, maintaining a database of users and related load preferences;
maintaining a database of available loads and related load information; and
generating a natural language load alert message when an available load matches load preferences of a user.

2. The computer-implemented method of claim 1 further comprising sending the natural language load alert message as a voice message to the user using telephony services.

3. The computer-implemented method of claim 2 further comprising receiving a voice instruction from the user in response to the natural language load alert message as a voice message.

4. The computer-implemented method of claim 1 wherein the users are independent capacity providers.

5. The computer-implemented method of claim 1 wherein load preferences are selected from the group consisting of type, expiration date, origin city, origin state, origin radius, pickup date, destination city, destination state, destination radius, preloaded, trailer group, trailer type, rate per mile, minimum revenue, team load, subscription name, status, and contact telephone number.

6. The computer-implemented method of claim 1 wherein the load information is selected from the group consisting of type, origin city/state, destination city/state, schedule information, and financial information.

7. The computer-implemented method of claim 1 wherein generating a natural language load alert message comprises:
building a load alert text message from the match; and
converting the load alert text message to a natural language load alert voice message.

8. The computer-implemented method of claim 1 wherein the database of available loads comprise freight.

9. The computer-implemented method of claim 3 wherein the voice instruction comprises an instruction to suspend sending a subsequent natural language load alert message.

10. The computer-implemented method of claim 1 further comprising generating a natural language load alert message when information pertaining to the available load changes.

11. The computer-implemented method of claim 1 further comprising generating a natural language load alert message when information pertaining to the available load matches a predicated location of the user.

12. A system comprising:
a subscription management module enabling a first type of user to manage information pertaining to load preferences and a second type of user to manage information pertaining to available loads;
a notification services module enabling a generation of a load alert text message when an available load matches load preferences of a user; and
a delivery services module enabling conversion of the load alert text message to a natural language load alert voice message and sending of the natural language alert voice message to the user over telephony services.

13. The system of claim 12 wherein the delivery services module comprises a speech server.

14. The system of claim 13 wherein the speech server comprises:
speech engine services (SES); and
telephone application services (TAS).

15. The system of claim 14 wherein SES enables scalable and fault-tolerant access to speech recognition and text-to-speech (TTS) resources for telephony and multimodal applications.

16. The system of claim 12 wherein information pertaining to load preferences is selected from the group consisting of type, expiration date, origin city, origin state, origin radius, pickup date, destination city, destination state, destination radius, preloaded, trailer group, trailer type, rate per mile, minimum revenue, team load, subscription name, status, and contact telephone number.

17. The system of claim 12 wherein information pertaining to available loads is selected from the group consisting of type, origin city/state, destination city/state, schedule information, and financial information.

18. The system of claim 12 wherein delivery services module enables receipt of a voice instruction from the user.

19. The system of claim 12 wherein available loads represent freight.

20. The system of claim 12 wherein the first type of user is an independent capacity provider.

21. The system of claim 12 wherein the second type of user is an agent.
